(19) United States
(12) Patent Application Publication
(10) Pub. No.: US 2023/0323749 A1
(43) Pub. Date: Oct. 12, 2023

(54) SELF-ADJUSTING CONNECTION SYSTEM

(71) Applicant: Vetco Gray Scandinavia AS, Stavanger (NO)

(72) Inventors: Morten Voldsund KARLSEN, Lier (NO); Staale SVINDLAND, Skreia (NO); Anver HUSSAIN, Asker (NO)

(21) Appl. No.: 18/003,830

(22) PCT Filed: Jun. 24, 2021
(86) PCT No.: PCT/EP2021/025232

§ 371 Date: Dec. 29, 2022

(30) Foreign Application Priority Data
Jul. 3, 2020 (NO) 20200779

(51) Int. Cl. E21B 43/013; F16L 1/10; E21B 33/038

(52) U.S. Cl. CPC E21B 33/038; E21B 43/013; F16L 1/10

(57) ABSTRACT

The invention relates to a connection system for connecting lines requiring angular orientation to land based or subsea production structures, the system including a connector (200) and a connector receiver (100) secured to a production structure surface (110) adapted to receive the connector. The connector receiver includes guide slots (108) for receiving guide keys (208) of the connector. The guide slots serve to guide the connector into angular and axial alignment with the connector receiver and to provide a soft landing preventing damage to the connecting ends.

### FIELD OF THE INVENTION

The invention relates to a multi bore connection system for connecting lines requiring a specific angular and axial orientation to land based or subsea production structures. More specifically, the invention relates to a vertical multi bore connection system.

### BACKGROUND

Jumpers are used to connect lines between production structures such as Christmas trees, manifolds, subsea or topside wells, pipelines or PLETs, typically flow lines or umbilicals. When connecting lines such as multi bore flowlines, multi core electric cables or umbilicals, their connection ends need to be both axially and angularly aligned. The connection procedure may inflict damage on the connection ends or internal components such as seals if the connection ends are not axially or angularly aligned. The present invention seeks to provide a safe, robust and easy to use connection system for guiding a connector into axial and angular alignment with a connector receiver.

### SUMMARY OF THE INVENTION

The invention relates to a connection system for connecting a line with multiple bores and/or cables requiring an axial and angular orientation to subsea structures, including a connector forming a female connection part with at least one guide key, the at least one guide key forming a protrusion on an inner surface of a bottom connector portion of the connector. The connection system further includes a connector receiver forming a male connection part secured to a subsea installation surface including at least one guide slot including a funnel shaped portion and a straight end portion, the at least one guide slot forming a recess in an outer surface of the connector receiver, wherein the at least one guide slot is adapted to receive the guide key of the connector for guiding the connector into angular alignment with the connector receiver upon connection.

The invention further relates to said connection system, wherein the connector includes a top connector portion and a bottom connector portion, the top connector portion having a smaller diameter than the bottom connector portion; and wherein the connector receiver includes a top connector receiver portion and a bottom connector receiver portion, the top connector receiver portion having a smaller diameter than the bottom connector receiver portion.

The invention further relates to said connection system, wherein the connector includes a frustoconical connector portion between the top connector portion and the bottom connector portion; the connector receiver includes a frustoconical connector receiver portion between the top connector receiver portion and the bottom connector receiver portion; and wherein the frustoconical connector portion conforms to the frustoconical connector receiver portion.

The invention further relates to said connection system, wherein the connector includes a clamping device and a clamping device interface for actuating the clamping device.

The invention further relates to said connection system, wherein the connector receiver includes a flanged head on a top end of the connector receiver adapted to be received the clamping device.

The invention further relates to said connection system located subsea.

The invention further relates to said connection system wherein the connector receiver is vertically oriented.

The invention further relates to said connection system wherein all guide keys of the connector are replaced with guide slots, and correspondingly all guide slots of the connector receiver are replaced with guide keys, the guide slots of the connector being oriented to receive the guide keys of the connector receiver.

The invention further relates to the connector according to said connection system.

The invention further relates to the connector receiver according to said connection system.

### BRIEF DESCRIPTION OF THE FIGURES

FIG. 1 is a perspective view of a connector receiver according to the invention;

FIG. 2 is an elevation of FIG. 1;

FIG. 3 is a perspective view of a connector according to the invention;

FIG. 4 is a perspective view of FIG. 3 from below;

FIG. 5 is a cross-sectional view of the connector of FIG. 3;

FIG. 6 is a perspective view of a connection system of the invention during connection; and

FIG. 7 is a perspective view of the connection system of FIG. 6 fully connected.

FIGS. 8A, 8B and 8C are side views of an alternative connector receiver and the mating process with a corresponding connector in three steps

FIG. 9 is a cross-sectional side view showing internal elements of the connector and the connector receiver according to the invention.

### DETAILED DESCRIPTION OF THE INVENTION

Terms like ‘bottom’, ‘top’, ‘upper’, ‘lower’, ‘beneath’, ‘above’, ‘below’, ‘raising’ and ‘lowering’ are to be interpreted as relative to the object(s) at hand in its orientation as described or depicted in the figures, not necessarily relative to their environment.

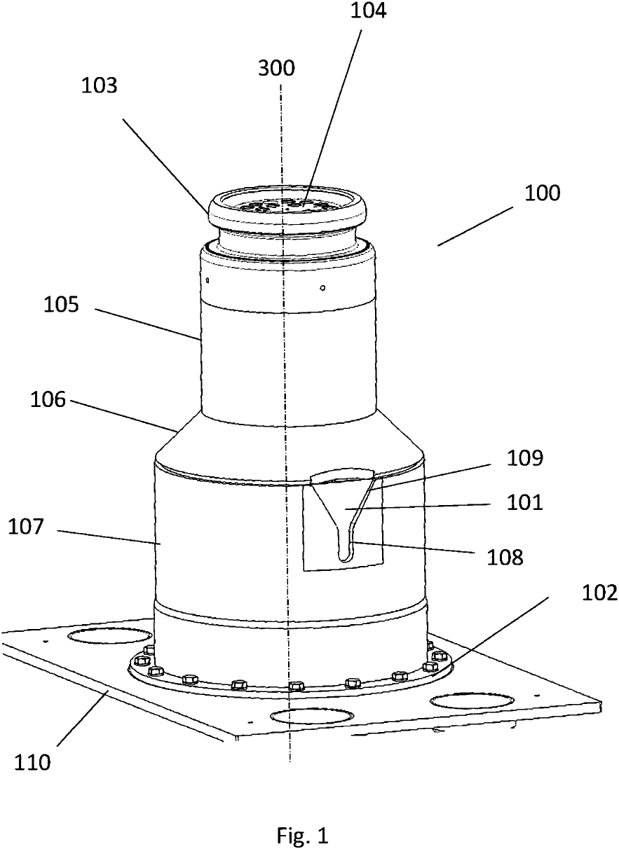

FIG. 1 is a perspective view of a connector receiver 100 for providing a connection interface for production structures, Christmas trees, manifolds, subsea or topside wells, energy producing structures, wind mills and other electric structures, pipelines or PLETs, the connector receiver 100 being adapted to receive lines such as umbilicals, multicore electric cables or any line requiring a specific angular and axial orientation. When connecting lines such as flowlines, cables or umbilicals, their connection ends need to be both axially and angularly aligned. The term ‘angular alignment’ is referred to as both the rotation angle about the centre axes of the two connecting lines and/or the angle between the axes as such, unless otherwise specified.

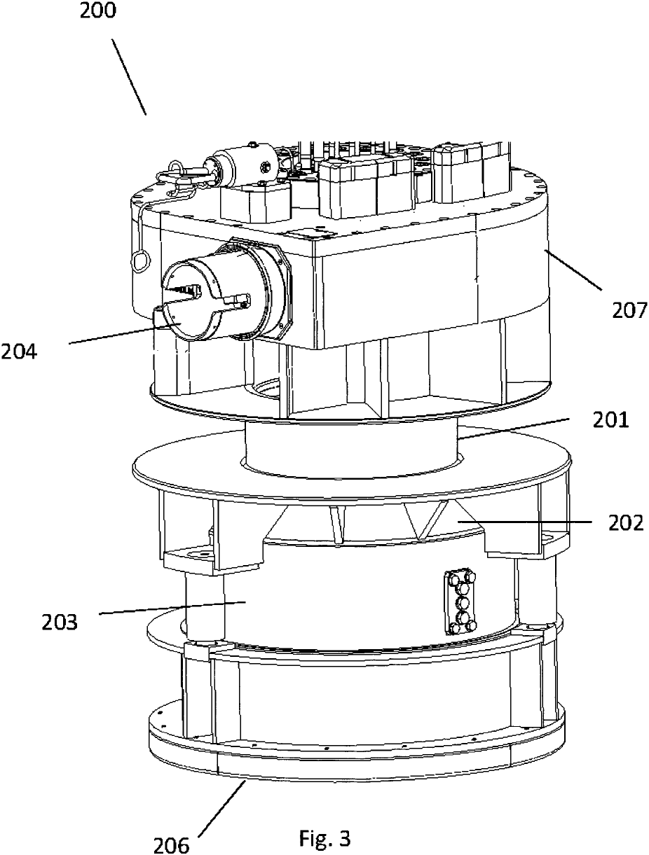

The connector receiver 100 is secured to a production structure surface 110 with a bolt type flange 102. The production structures may be located subsea or on land. The connector receiver can be vertically oriented but may also be oriented in any other angle. The connector receiver 100 includes a flanged head 103 on its top end for receiving a clamping device 207 (see FIG. 3), and a multi bore interface 104.

In FIG. 1, the connector receiver 100 includes a top connector receiver portion 105 forming a cylindrical outer surface with a smaller diameter than a bottom connector receiver portion 107 also forming a cylindrical outer surface, and a frustoconical portion 106 between the top connector receiver portion 105 and the bottom connector receiver portion 107.

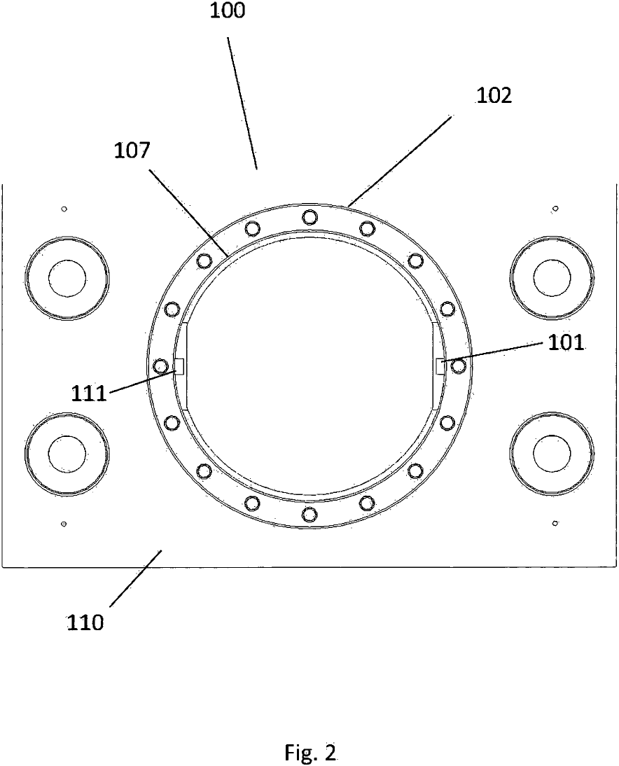

The connector receiver 100 includes a first guide slot 101 forming a recess in the outer surface of the bottom connector receiver portion 107 and in the outer surface of the frustoconical portion 106. The connector receiver 100 may also include a second guide slot 111 (see FIG. 2) identical to the first guide slot 101. The connector receiver 100 may also include more than two guide slots.

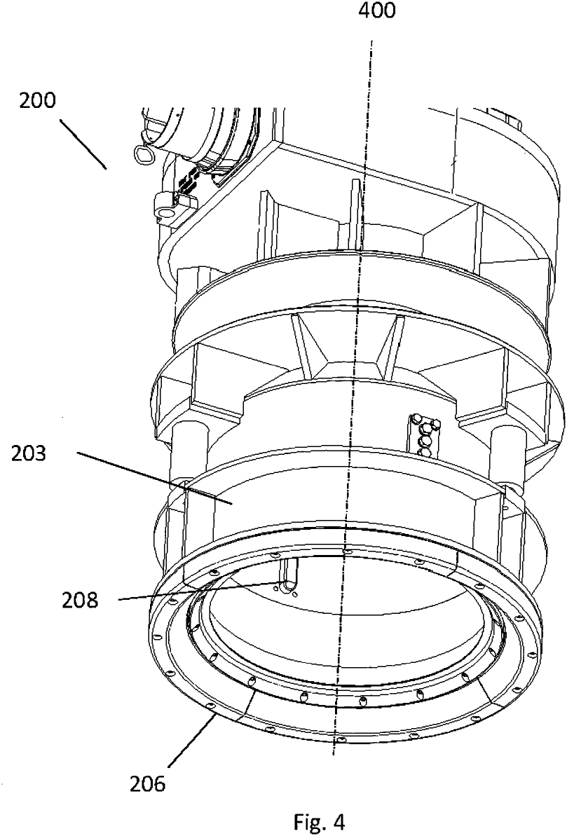

The first guide slot 101 includes a funnel shaped portion 109 and a straight end portion 108 beneath the funnel shaped portion 109. The width of the funnel shaped portion is referred to as the capture range. The first guide slot 101 is shaped to receive a guide key 208 of a connector 200 (see FIG. 4) guiding the centre axis of the connector 200 to axial and angular alignment with respect to the centre axis of connector receiver 100. The funnel shaped portion 109 serves as a widened entry point gradually narrowing down to the straight end portion 108, thereby allowing an angled entry of the guide key 208, providing a soft landing for the connector 200. Resultingly, the connector 200 is not required to be completely angularly aligned with the connector receiver 100 when they are moved into contact.

FIG. 2 is an elevation of the connector receiver 100 shown in FIG. 1 with a cross-sectional view of the bottom connector receiver portion 107. FIG. 2 further shows the bolt type flange 102 and the production structure surface 110, the first guide slot 101 and a second guide slot 111 identical to the first guide slot 101 located on the opposite side of the connector receiver. Although in FIG. 2, the guide slots 101, 111 are spaced 180° apart about the connector receiver centre axis 300, (FIG. 1) the angular distance between the guide slots 101, 111 may also be smaller than 180°, e.g. between 45° and 180°.

FIG. 3 is a perspective view of a connector 200 including a hollow cylindrical end portion 206. The connector 200 forms a female connection part adapted to mate with the connector receiver 100 (see FIG. 1), the connector receiver 100 forming a corresponding male connector part. The connector 200 is typically fitted to the end of a jumper (not shown) housing a line including multiple bores and/or cables. The jumper piping houses the same line as the connector receiver 100. The connector 200 includes a top connector portion 201 with a smaller diameter than a bottom connector portion 203 and a frustoconical portion 202 between the bottom connector portion 203 and the top connector portion 201. The top connector portion 201 is dimensioned to fit on the outside of the top connector receiver portion 105, the tubular frustoconical portion 202 is dimensioned to fit on the outside of the frustoconical portion 106 and the bottom connector portion 203 is dimensioned to fit on the outside of the bottom connector receiver portion 107 (see FIG. 1). The connector 200 further includes a clamping device 207 provided with a clamping device interface 204 for tightening or loosening the clamping device 207. The clamping device 207 is typically a conventional clamp connector, and the clamping device interface 204 is typically a conventional torque reaction bucket. The clamping device interface 204 may be operated by an ROV.

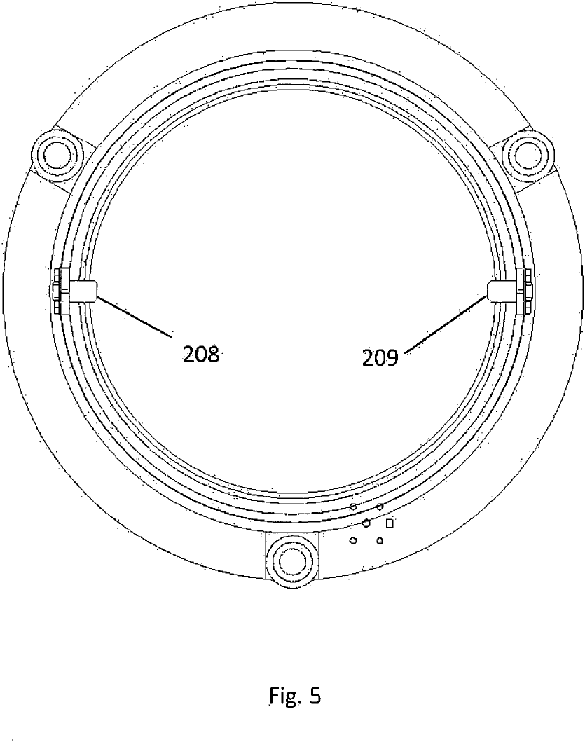

FIG. 4 is a perspective view of the connector 200 of FIG. 3 from below and shows the tubular end portion 206. The connector 200 includes a first guide key 208 forming a protrusion on the inner surface of the bottom connector portion 203 to be received by the guide slot 101, 111 of the connector receiver 100 (see FIG. 1). The connector 200 may further include a second guide key 209 (see FIG. 5). The guide keys 208, 209 are shaped to fit the straight end portion 108 of the guide slots 101, 111. The guide keys 208, 209 and the corresponding straight end portions 108 may be oblong to prevent movement of the connector 200 out of alignment with the connector receiver 100. The connector 200 may include more than two guide keys, however the number of guide slots (see FIG. 1) of the connector receiver 100 must be equal to or greater than the number of guide keys.

Alternatively the guide keys 208, 209 of the connector 200 may be replaced with guide slots 101, 111, and correspondingly the guide slots 101, 111 of the connector receiver 100 may be replaced with guide keys 208, 209. In this embodiment the guide slots 101, 111 of the connector 200 are oriented to receive the guide keys 208, 209 of the connector receiver 100.

FIG. 5 is a cross-sectional view of the connector of FIG. 3, more specifically a cross section of the bottom connector portion 203. FIG. 5 shows the first guide key 208 and a second guide key 209 identical to the first guide key located diametrically opposite to the first guide key 208. In FIG. 5 the guide keys 208, 209 are spaced 180° apart about the connector centre axis 400 (see FIG. 4), although the angular distance between the guide keys 208, 209 may be smaller than 180°, e.g. between 45° and 180°. In any case, the angular distance between two guide keys 208, 209 of the connector 200 correspond to the angular distance between two guide slots 101, 111 of the connector receiver 100 (see FIG. 2).

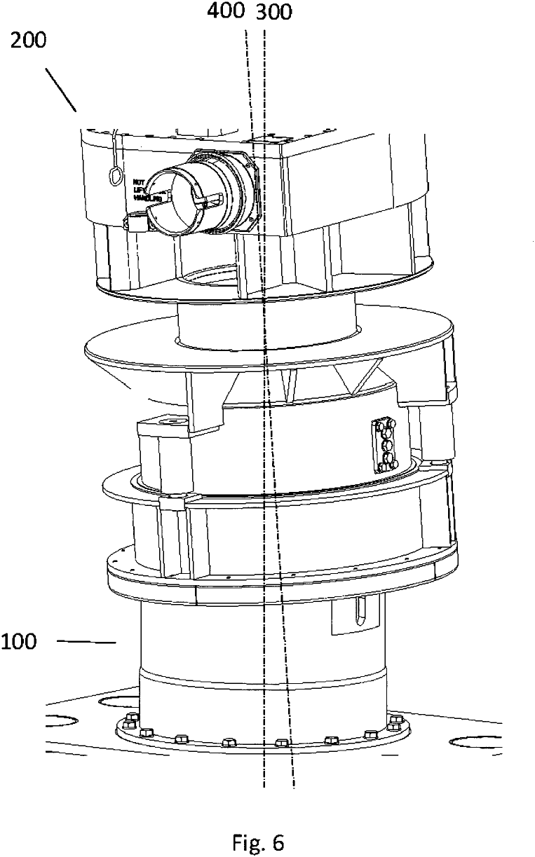

FIG. 6 is a perspective view of a connection system of the invention including the connector receiver 100 and the connector 200 during connection. Upon mating, the centre axes of connector 200 and the connector receiver 100 can be misaligned such as depicted in FIG. 6.

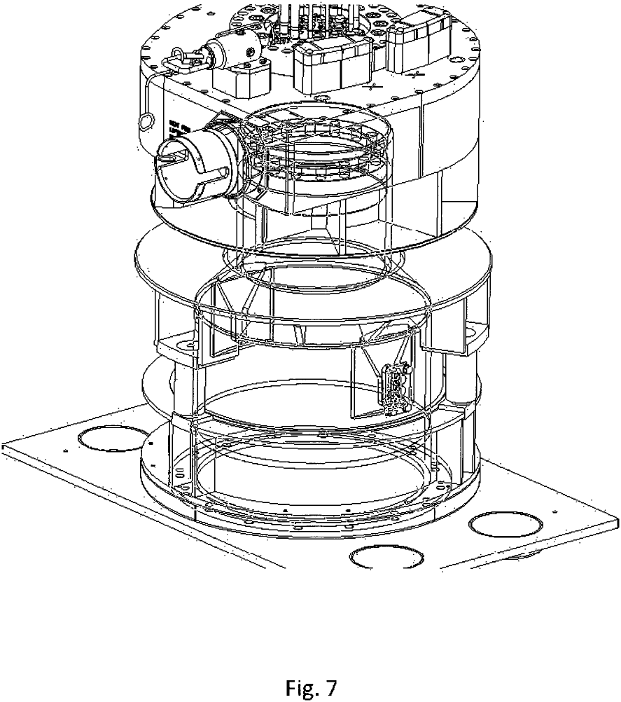

FIG. 7 is a perspective view of a connection system fully connected wherein the connector (200) is transparent.

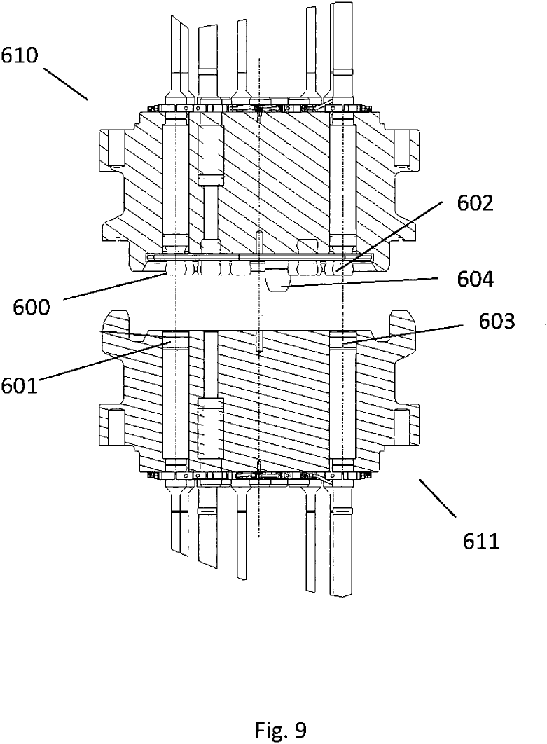

Reference is made to FIG. 1 to FIG. 7. In order to mate the connector receiver 100 with the connector 200, the connector 200 is positioned above the connector receiver 100 and lowered. While lowering, the connector 200 is rotated so that its guide keys 208, 209 fall within the capture range of the guide slots 101, 111. After this rotation, the connector 200 is lowered further, and the guide keys 208, 209 engages the guide slots 101, 111 through which the funnel shaped portion 109 guides the guide keys 208, 209 to the straight end portion 108 when lowering the connector 200. When the guide keys 208, 209 reach the end of the straight end portion 108, the connector 200 and the connector receiver 100 are substantially axially and angularly aligned. A last fine orientation is conducted by means of connector pins (see FIG. 9). The clamping device 207 may be actuated using the clamping device interface 204, engaging the flanged head 103.

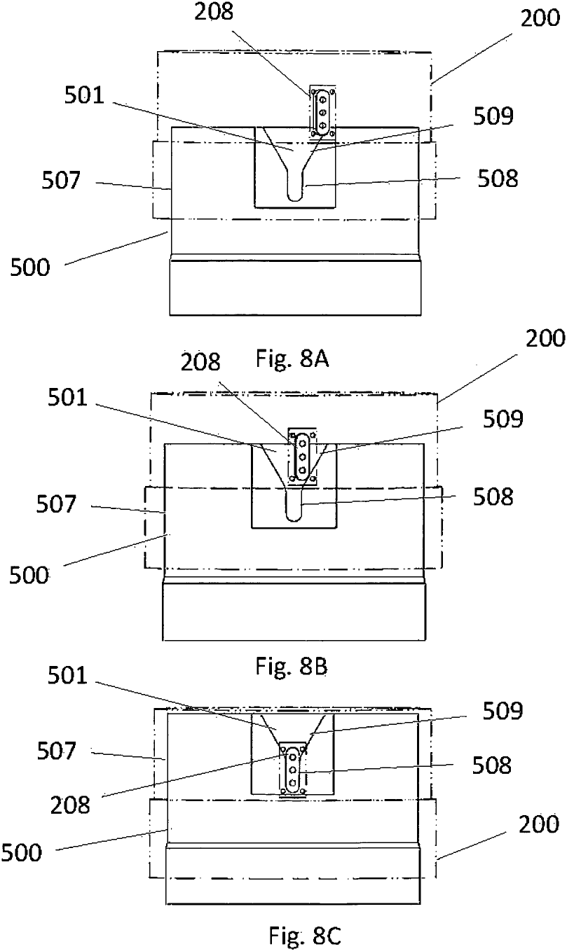

FIGS. 8A, 8B and 8C are side views of an alternative connector receiver 500 and shows the mating process with a corresponding connector 200 in three steps. The alternative connector receiver 500 has a cylindrical outer surface 507 with one single diameter from its top extending to a level beneath a straight end portion 508 of a guide slot 501. The alternative connector receiver 500 may include an additional guide slot (not shown) on its opposite side, spaced 180° apart from the guide slot 501. The alternative connector receiver 500 may include multiple guide slots. The angular distance between the guide slots may also be smaller than 180°, e.g. between 45° and 180°.

In FIG. 8A a first guide key 208 of the connector 200 is positioned slightly within the capture range of a funnel shaped portion 509 of a guide slot 501 of the alternative connector receiver. In FIG. 8B the connector 200 is positioned lower than FIG. 8A. FIG. 8B shows how the guide slot 501 forces the first guide key 208 and thereby connector 200 to rotate about its centre axis. In FIG. 8C the connector 200 is in its final position and the first guide key 208 has reached the end of the straight end portion 508.

FIG. 9 is a cross-sectional side view showing internal elements of the connector 200 and the connector receiver 100 as shown in FIG. 1 and FIG. 3. FIG. 9 shows a first internal cut-out 610 of the connector 200 and a second internal cut-out 611 of the connector receiver 100. In FIG. 9 the first internal cut-out 610 includes a first connector bore 600 and a second connector bore 602. Correspondingly, the second internal cut-out 611 includes a first connector receiver bore 601 for receiving the first connector bore 600 and a second connector receiver bore 603 for receiving the second connector bore 602. Furthermore, FIG. 9 shows a male connector pin 604 adapted to be received by a female connector pin receiver (not shown) aligning the connector 200 with the connector receiver 100 when mated. The connector 200 and the connector receiver 100 may include a plurality of connector pins and connector pin receivers. The connector pin 604 can be extendable and/or conductive, and provides a last fine orientation step to the mating process.

| | | | |
|---|---|---|---|
| 100 | Connector receiver | 207 | Clamping device |
| 101 | First guide slot | 208 | First guide key |
| 102 | Bolt type flange | 209 | Second guide key |
| 103 | Flanged head | 500 | Alternative connector receiver |
| 104 | Multi bore interface | 501 | Guide slot |
| 105 | Top connector receiver portion | 507 | Cylindrical outer surface |
| 106 | Frustoconical portion | 508 | Straight end portion |
| 107 | Bottom connector receiver portion | 509 | Funnel shaped portion |
| 108 | Straight end portion | 600 | First connector bore |
| 109 | Funnel shaped portion | 601 | First connector receiver bore |
| 110 | Production structure surface | 602 | Second connector bore |
| 111 | Second guide slot | 603 | Second connector receiver bore |
| 300 | connector receiver centre axis | 604 | Connector pin |
| 400 | connector centre axis | 610 | First internal cut-out |
| 200 | Connector | 611 | Second internal cut-out |
| 201 | Top connector portion | | |
| 202 | Tubular frustoconical portion | | |
| 203 | Bottom connector portion | | |
| 204 | Clamping device interface | | |
| 206 | Tubular end portion | | |

1. A connection system for connecting a line with multiple bores and/or cables requiring an axial and angular orientation to subsea structures, comprising:
a connector forming a female connection part with at least one guide key, the at least one guide key forming a protrusion on an inner surface of a bottom connector portion of the connector;
a connector receiver forming a male connection part secured to a subsea installation surface comprising at least one guide slot comprising a funnel shaped portion and a straight end portion, the at least one guide slot forming a recess in an outer surface of the connector receiver, wherein the at least one guide slot is adapted to receive the guide key of the connector for guiding the connector into angular alignment with the connector receiver upon connection.

2. The connection system of claim 1, wherein:
the connector comprises a top connector portion and a bottom connector portion, the top connector portion having a smaller diameter than the bottom connector portion; and
wherein the connector receiver includes a top connector receiver portion and a bottom connector receiver portion, the top connector receiver portion having a smaller diameter than the bottom connector receiver portion.

3. The connection system of claim 2 wherein:
the connector comprises a frustoconical connector portion between the top connector portion and the bottom connector portion;
the connector receiver comprises a frustoconical connector receiver portion between the top connector receiver portion and the bottom connector receiver portion; and
wherein the frustoconical connector portion conforms to the frustoconical connector receiver portion.

4. The connection system according to claim 1, wherein the connector comprises a clamping device and a clamping device interface for actuating the clamping device.

5. The connection system according to claim 1, wherein the connector receiver comprises a flanged head on a top end of the connector receiver adapted to be received the clamping device.

6. The connection system according to claim 1, located subsea.

7. The connection system according to claim 1, wherein the connector receiver is vertically oriented.

8. The connection system according to claim 1, wherein all guide keys of the connector are replaced with guide slots, and correspondingly all guide slots of the connector receiver are replaced with guide keys, the guide slots of the connector being oriented to receive the guide keys of the connector receiver.

9. The connector according to claim 1.

10. The connector receiver according to claim 1 .
